(19) United States
(12) Patent Application Publication
(10) Pub. No.: US 2015/0358079 A1
(43) Pub. Date: Dec. 10, 2015

(54) VISIBLE LIGHT COMMUNICATION IN A MOBILE ELECTRONIC DEVICE

(71) Applicant: GrandiOs Technologies, LLC, Wilmington, DE (US)

(72) Inventor: John Cronin, Bonita Springs, FL (US)

(21) Appl. No.: 14/633,093

(22) Filed: Feb. 26, 2015

Related U.S. Application Data
(60) Provisional application No. 62/007,861, filed on Jun. 4, 2014.

(51) Int. Cl. H04B 10/116

(52) U.S. Cl. CPC H04B 10/116

(57) ABSTRACT

Systems and methods for visible light communications (VLC) are provided. As such, VLC may be configured and used in a mobile electronic device. In certain instances, the location of a mobile electronic device may be used to identify a communication protocol and visible light communications light source that transmits VLC communications at that location. A user device may receive information from a radio network that enables the mobile device to receive and decode communications transmitted using light at various geo-locations.

### CROSS-REFERENCE TO RELATED APPLICATIONS

The present application claims the priority benefit of U.S. provisional application number 62/007,861 filed Jun. 4, 2014 and entitled “Visible Light Communication in a Mobile Electronic Device,” the disclosure of which is incorporated herein by reference.

### BACKGROUND OF THE INVENTION

1. Field of the Invention

The invention relates to the use of visible light communication in a mobile electronic device. More specifically the invention relates to the mobile electronic device decoding messages contained in visible light communication and presenting those messaged to a user of the mobile electronic device.

2. Description of the Related Art

Visual light communications (VLC) are an emerging form of communications that use line of sight, i.e., visual forms of light emitters to communicate data wirelessly. VLC uses a light source that is frequency modulated, or uses a light source that is turned on and off rapidly when transmitting a communication. In either instance, the technology enables the use of a visible light to communicate a message by manipulating the light source.

Visible light communications may be classified according to whether the communication is transmitted according to a standard communication protocol without encryption, whether the transmission is transmitted using a standard communication protocol with encryption, or whether the communication is transmitted using a proprietary communication protocol that may or may not include encrypted information. A visible light communication may either modulate the frequency of a visible light or may turn the light on and off rapidly when transmitting a communication. In either instance, the visible light may communicate a message using a transmission technique and a communication protocol.

Visible light communications use electromagnetic emissions that generally travel in a line-of-sight. Light cannot travel around corners, unless it is reflected through a highly reflective surface that allow the light to be reflected in a line-of-sight. Light also cannot travel through solid obstacles. Infrared, while not visible to people, is visible to certain insects and detectable by devices. Infrared also travels in a line of sight. Therefore, infrared may be considered a “visible” light, and infrared LEDs may be used to communicate VLC communications. In contrast, radio is a form of electromagnetic transmission that may pass through obstacles and may travel around corners.

Since VLC is an emerging technology, very few applications and virtually no systems have been developed for consumers to benefit from VLC. There is therefore an opportunity for VLC communications to be integrated into mobile electronic devices in various ways.

### SUMMARY OF THE CLAIMED INVENTION

Embodiments of the present invention may enable visible light communications to be configured and used in a mobile electronic device. In certain instances, the location of a mobile electronic device may be used to identify a communication protocol and visible light communications light source that transmits VLC communications at that location. A user device may receive information from a radio network that enables the mobile device to receive and decode communications transmitted using light at various geo-locations.

Various embodiments of the present invention may include methods for enabling visible light communications on mobile devices. Such methods may include receiving a visible light communications signal. Such a visible light source communication signal includes an encoded message. Methods may further include decoding the encoded message embedded within the visible light communications signal, and presenting the message to a user of a mobile electronic device. Messages may be presented by a mobile electronic device using means that include, yet are not limited to, displaying the message on a user interface, sounding a ringtone, emitting an audio message, and initiating a vibration.

Additional embodiments of present invention may include a non-transitory computer readable medium executable on a processor that may be implemented in a system consistent with certain embodiments of the invention.

### BRIEF DESCRIPTION OF THE DRAWINGS

FIG. 1 shows a mobile electronic device and various light-emitting devices that may be used in an exemplary system for enabling visible light communications on mobile devices.

FIG. 2 illustrates an exemplary network environment in which a system enabling visible light communications on mobile devices may be implemented.

FIG. 3 illustrates a user interface for controlling settings on a smart device that may be used in a system for enabling visible light communications on mobile devices.

FIG. 4 is a flowchart illustrating an exemplary method for enabling visible light communications on mobile devices.

FIG. 5 illustrates an exemplary database on a smart device that may be used in a system for enabling visible light communications on mobile devices.

FIG. 6 illustrates another exemplary database on a smart device that may be used in a system for enabling visible light communications on mobile devices.

FIG. 7 illustrates a mobile device architecture that may be utilized to implement the various features and processes described herein

### DETAILED DESCRIPTION

Certain embodiments of the invention allow a user to configure settings relating to visible light communication on a mobile electronic device. In certain instances, at least one of these settings is in an operating system setting in the operating system of a mobile electronic device. Once the mobile electronic device is set to receive visible light communications, the mobile electronic device may receive a visible light communication through a sensor on or connected to the mobile electronic device.

In certain instances, when the mobile electronic device receives a visible light communication, it may attempt to decode a message contained in the visible light communication. In such instances, the mobile electronic device may identify the transmission technique and the communication protocol. The mobile electronic device may observe a visible light communication and identify the type of the visible light communication being observed, when possible. When the mobile electronic device determines that it can identify the type of visible light communication being observed, the mobile electronic device may decode at least a portion of the communication.

In the instance where the mobile electronic device determines that the visible light communication uses standard communication protocol without encryption, the mobile electronic device may decode a message in the communication. After decoding the message, the mobile electronic device may present it to the user of the mobile electronic device.

In the instance where the mobile electronic device determines that the visible light communication uses a standard communication protocol with encryption, the mobile electronic device may decode a portion of the communication. When the mobile electronic device is in possession of one or more encryption keys that can decode the entire communication, the mobile electronic device may decode and decrypt the communication. After decoding and decrypting the message, the mobile electronic device may present it to the user of the mobile electronic device.

In the instance where the communication protocol used by the visible light communication is proprietary, the mobile electronic device may only be able to decode the communication when it is aware of the proprietary data communication protocol. The mobile electronic device may also be able to decrypt a proprietary visible light communication when it has decryption keys associated with the encryption. Here again, messages may be presented to a user of the mobile electronic device after a communication has been decoded and/or decrypted in whole or in part.

Messages may be presented by smart device 105 using means that include, yet are not limited to displaying the message on a user interface, sounding a ringtone, emitting an audio message, and initiating a vibration. Preferences for a selecting preferred methods for presenting a message to a user may typically be set through in a settings window in a user interface on smart device 105. The message may be presented using any form of audio, visual, or mechanical stimulation. For example, an audio message emitted may be “slippery road surface ahead, drive with caution”. In certain instances, the such an audio message is emitted after smart device 105 receives an indication of slippery road surfaces from a light emitter from another vehicle.

Embodiments of the invention also include combining visible light communications with geo-location. In certain of such embodiments, the mobile electronic device may receive a transmission from an external electronic device using a radio signal. Radio signals that may be used by systems consistent with the invention include, yet are not limited to a Wi-Fi signal, a Bluetooth signal, a 3G cellular signal, 4G cellular signal, and a near field data communication signal.

Radio signals received by the mobile electronic device include communications that inform the mobile electronic device of the types and communication protocols of visible light communications that are available at the location where the mobile electronic device is currently located. For example, when it is determined that the geo-location of a mobile electronic device is at a Starbucks, an external electronic device may transmit a radio communication to the mobile electronic device informing the mobile electronic device of the type and the communication protocol of visible light communications used at Starbucks.

In certain instances the geo-location of the mobile electronic device may be determined by the mobile electronic device itself using global positioning satellite (GPS), or a form of assisted GPS (AGPS).

Mobile station assisted GPS is an example of a system determining the location of a handheld device using data received by the handheld device in calculations. This form of assisted GPS uses snapshot of GPS data received by the handheld device that is transmitted to (and received by) a system. Such a system using high quality GPS signals received by the system itself, can compare the fragments of GPS data from the handheld device, and calculate a location. Similar location detection systems are common in the art. Frequently these systems use information from cell towers when determining the location of a handheld device. Alternatively, the location of a Wi-Fi hotspot received by a handheld device may be used to determine an approximate location.

In other instances, the geo-location of the mobile device may be determined by the user entering a location parameter into their mobile electronic device. Location parameters include, yet are not limited to an address, an intersection of roads, or a latitude and a longitude. Here again settings entered into a user interface of smart device 105 may be operating system settings in the operating system of smart device 105. In certain instances, these settings are settings in the Apple IOS of an iPhone.

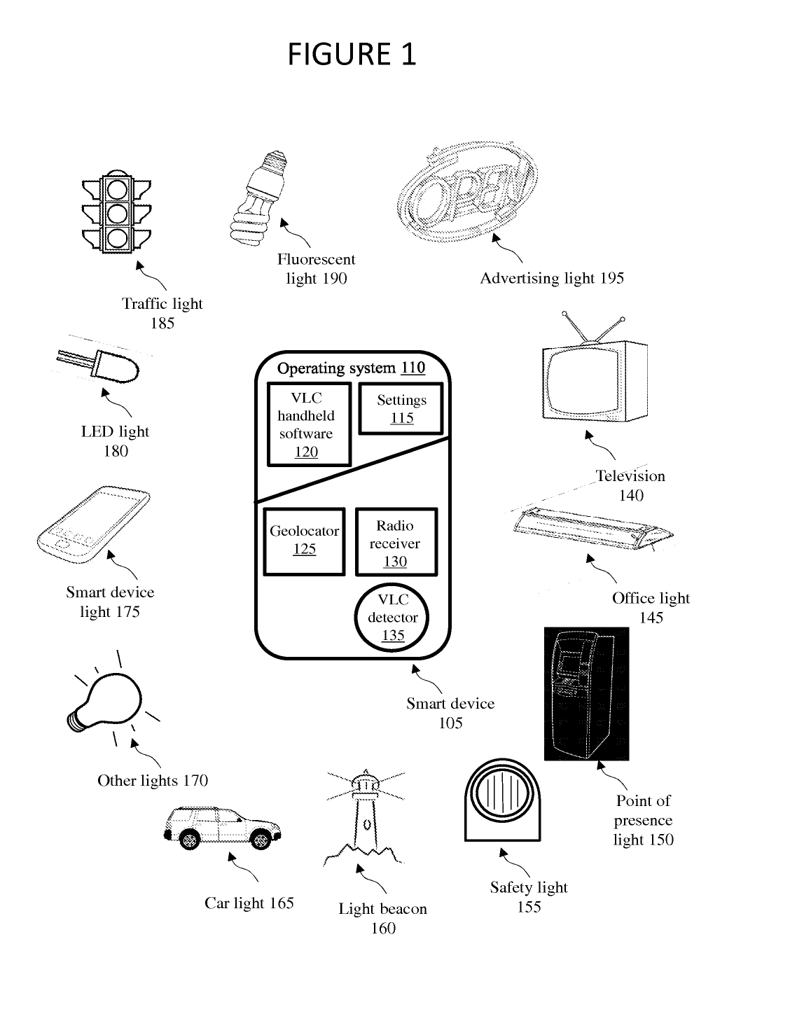

FIG. 1 shows a mobile electronic device 105 and various light-emitting devices 140-195 that may be used in an exemplary system for enabling visible light communications on mobile devices. Light-emitting devices 140-195 may include a television 140, an office light 145, a point of presence light 150, a safety light 155, a light beacon 160, a car light 165, other lights 170, a smart device light 175, an LED light 180, a traffic light 185, a fluorescent light 190, and advertising light 195. Any one of the lights in the figure may be used in a system that transmits visible light communications that may be received by smart device 105.

Smart device 105 may include settings 115, VLC handheld software 120, geo-locator 125, radio receiver 130, and VLC detector. Settings 115 may be settings that may be included in the operating system settings of the operation system on a smart device 105. VLC handheld software may be software used to receive visible light communications or to present messages to a user of smart device 105.

Geo-locator 125 may determine the geo-location of smart device 105. In certain instances, geo-locator 125 may use a GPS application installed on smart device 105 and/or a form of assisted GPS to determine the geo-location of smart device 105. In other instances, geo-locator 125 may include a user interface through which a user may enter an address, an intersection of roads, or a latitude and a longitude. Depending on the implementation, geo-locator 125 may be implemented in hardware, software, or combination of hardware and software.

Radio receiver 130 may be a radio receiver commonly found in smartphones. Radio receiver 130 may receive radios signals that may include, yet are not limited to a Wi-Fi signal, a Bluetooth signal, a 3G cellular signal, a 4G cellular signal, and a near field data communication signal.

VLC detector 135 may be a sensor capable of sensing visible light communications. In certain instances, the sensor may be connected to smart device 105 through a communication port, such as a microphone input or a micro-USB port. In other instances, the sensor may be built into the smart device 105 and may form part of a camera in the smart device 105.

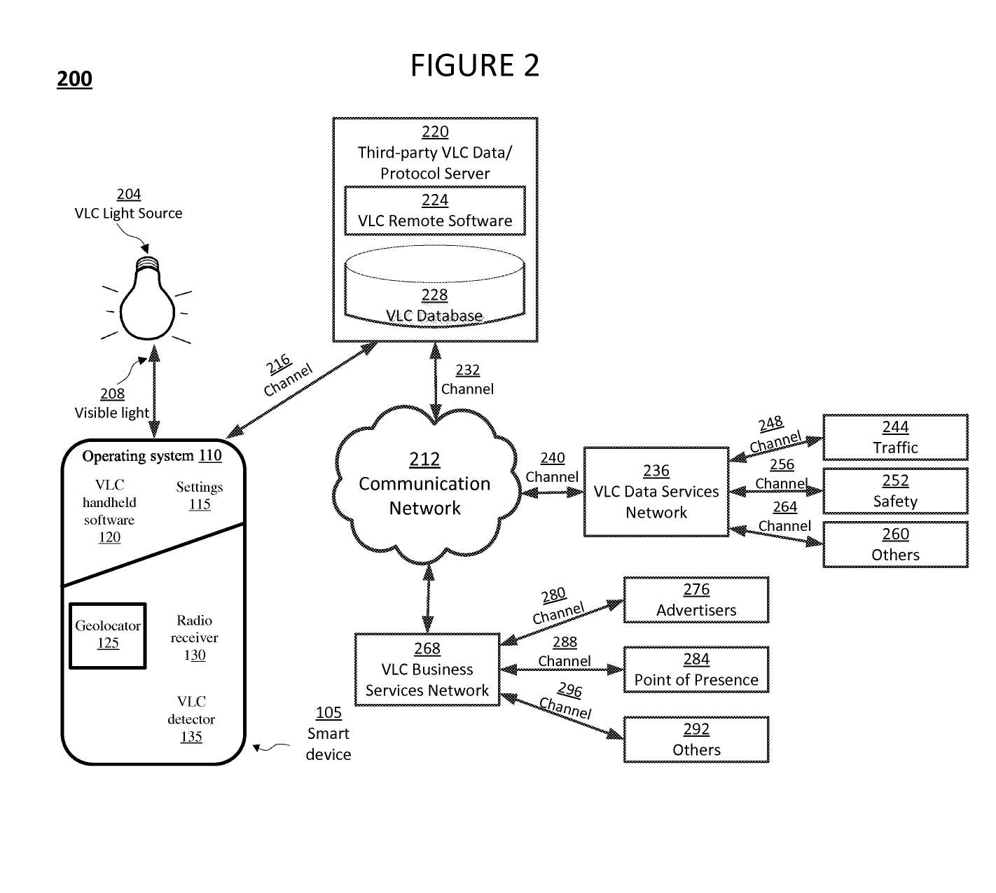

FIG. 2 illustrates an exemplary network environment 200 in which a system enabling visible light communications on mobile devices may be implemented. The smart device 105 in FIGURE may correspond to the smart device 105 of FIG. 1 and include corresponding settings 115, VLC handheld software 120, geo-locator 125, radio receiver 130, and VLC detector.

Network environment 200 may further include a visible light communication (VLC) light source 204, the Internet 212, a visible light 208 communication, several communication channels (216, 232, 240, 272, 248, 256, 264, 280, 288, and 296), a third party VLC data protocol server 220, VLC data services network 236, traffic 244, safety 252, others (260, & 292), VLC business services network 268, advertisers 276, and point of presence 284.

Third party VLC data protocol server 220 may include VLC remote software 224, and VLC database 228. The VLC data protocol server 220 may communicate with smart device 105 using communication channel 232, the Internet, and communication channel 208 when providing VLC services from a third party vendor. VLC remote software 224 may use the VLC database 228 when providing information describing VLC light sources at a geo-location. After smart device 105 reports a geo-location to the 3rd party data protocol server 220, VLC remote software 224 may query VLC database 228 for information relating to VLC light source 204. The 3rd party data protocol server 220 may then transmit that information to smart device 105, which may then be aware of the type of VLC and the communication protocol used by a visible light source 204 at the reported geo-location. With this information, smart device 105 may be able to decode and/or decrypt messages communicated by visible light source 204.

In certain instances, VLC data services network 236 and VLC business service network 268 provide messages to VLC light sources that may be broadcast to smart device 105 based on its geo-location from public or private sources. These network services may also update information stored in the VLC database 228 in the third party VLC data protocol server 220 by communicating periodic database updates through a data channel and the Internet.

Traffic 244, safety 252, and others 260 are systems providing geo-location information and messages through traffic signals, safety, or other broadcasts relating to public service. These public service based systems may transmit warnings regarding road conditions, storm warnings, other public service messages to vehicles as they drive the roadways, or when they are stopped at traffic lights. Similarly, VLC business services network 268 may provide messages from advertisers 276, point of presence 284, and other types of messages from private sources.

Communication channels (216, 232, 240, 272, 248, 256, 264, 280, 288, & 296) may be implemented by any data communication channel type known in the art, including various forms of wired communication channels, fiber optic communication channels, or wireless data communication channels. Such data communication channels include, yet are not limited to Ethernet, Fiber Channel, 3G cellular, 4G cellular, and Wi-Fi data communication channels.

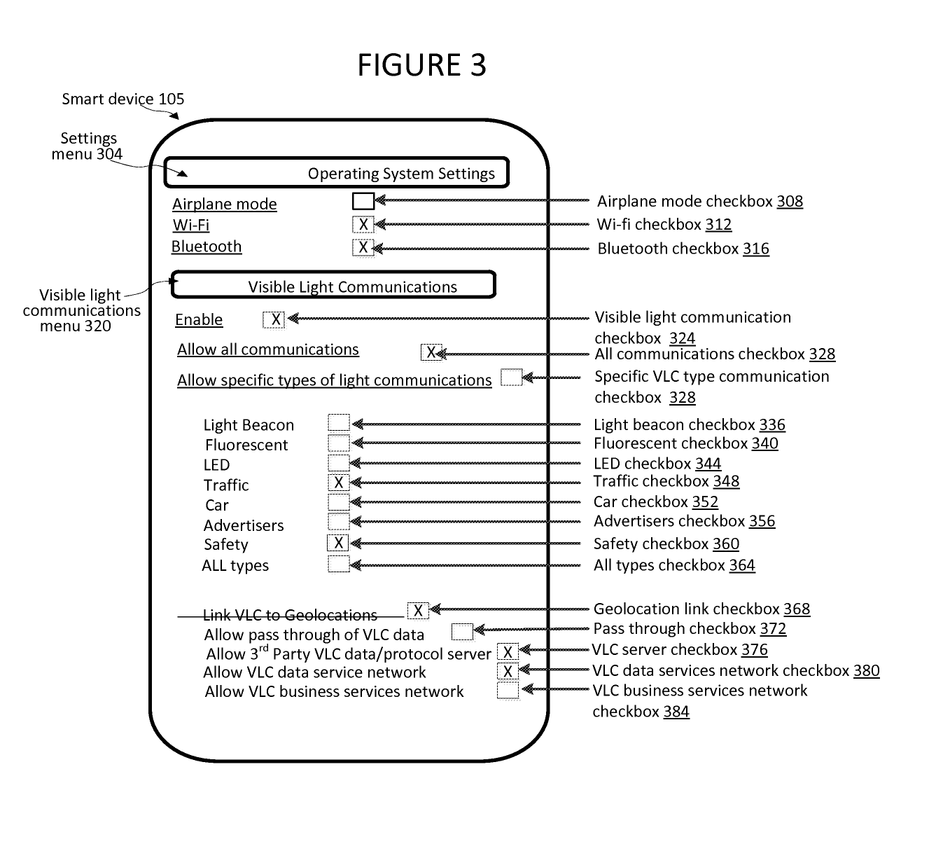

FIG. 3 illustrates a user interface for controlling settings on a smart device 105 that may be used in a system for enabling visible light communications on mobile devices.

The user interface of smart device 105 includes settings menu 304. Settings menu 304 includes an airplane mode check box 308, a Wi-Fi checkbox 312, and a Bluetooth checkbox 316. These checkboxes allow a user to enable or disable airplane mode, Wi-Fi, or Bluetooth operation on smart device 105.

In certain instances, when visible light communications 320 setting selection is selected, sub-menus may be displayed on smart device 105. Such sub-menus include numerous VLC configuration settings, including visible light communication checkbox 324, all communications checkbox 328, specific VLC type communication checkbox 332, light beacon checkbox, LED checkbox 344, traffic checkbox 348, car checkbox 352, advertisers checkbox 356, all types checkbox 364, geo-locations link check box 368, pass through checkbox 372, VLC server checkbox 376, VLC data services network checkbox, VLC business services network 384. These checkboxes enable or disable functions associated with types of VLC data communications, as well as different types of networks that use or configure VLC data communications.

Visible light communication checkbox 324 enables or disables basic VLC functions. All communications checkbox 328 enables all VLC functions. Specific VLC type communication checkbox 332 allows the user to enable or disable specific VLC communication types. Specific types of VLC communications shown in the figure include light beacon (light beacon checkbox 336), LEDs (LED checkbox 344), traffic signals (traffic checkbox 348), a car (car checkbox 352), advertiser (advertisers checkbox 356), and all types of VLC devices (all types checkbox 364).

The geo-locations link check box 368 enables or disables smart device 105 to receive information relating the geo-location of user device 105. The pass-through checkbox 372 enables VLC communications received by smart device 105 to be passed through to another VLC-enabled smart device. Communications may be passed through to other smart devices using a smart device light 175 in smart device 105.

VLC server checkbox 376 enables or disables smart device 105 to receive information from a VLC data protocol server. Such information received by smart device 105 enables smart device 105 to decode and/or decrypt VLC communications at identified geo-locations. VLC data services network checkbox and VLC business services network 384 enable smart device 105 to receive public or private messages from those networks.

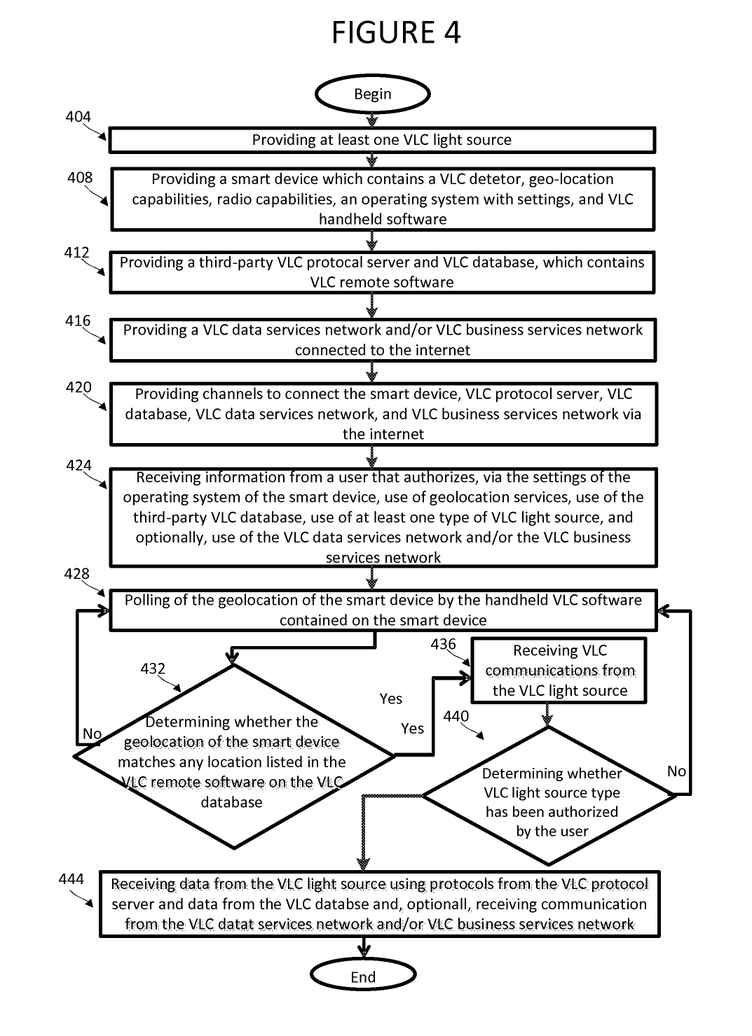

FIG. 4 is a flowchart illustrating an exemplary method 400 for enabling visible light communications on mobile devices. In step 404, at least one VLC light source is presented to and received by smart device 105. In step 408, a VLC device equipped smart device 105 is configured to provide geo-location, radio configuration settings using operating system settings, and VLC software on a handheld device.

In step 412, the services of a third party VLC protocol server are provided to smart device 105. This step may involve smart device 105 receiving information regarding VLC light sources in a geo-location using a 3rd party protocol server, a VLC database, and VLC software.

In step 416, services from a VLC data service and a VLC business services network are provided to a smart device. These networks may provide public services messages to the public or provide business messages or services to members of a private network.

In step 420, communication channels are initialized to receive communications from an internet based geo-location or messaging service. A smart device may be initialized to receive geo-location VLC information from a VLC protocol server. Further, a VLC data services network and VLC business services network may be initialized. In certain instances, these services were enabled using the user interface depicted in FIG. 3.

In step 424, smart device 105 may receive information from a user that authorizes the use of at least one type of VLC light source with geo-location data from a 3rd party VLC database. Optionally, information may be received from a VLC data services network or a VLC business services network. In certain instances, the settings used to configure VLC functionality in a smart device are located in the operating services settings of a smart device.

In step 428, a smart device is polled for its geo-location by VLC software running on smart device 105. In step 432, the smart device determines whether the geo-location of the device matches a location in the VLC database. When a match is determined, the method may proceed to step 436. When the geo-location of the smart device is not a geo-location in the VLC database, the method may returns to step 428.

In step 436, communications are received from a VLC light source. In step 440, it may be determined whether the VLC light source has been authorized by a user. Where that VLC light source has not been authorized, the method may return to step 428 where polling continues. Where the VLC light source has been authorized, the method may proceed to step 444 where data is received from the VLC protocol server regarding VLC light sources at an identified geo-location by smart device 105. Further, messages may be received by smart device 105 from a VLC data services network or a VLC business services network.

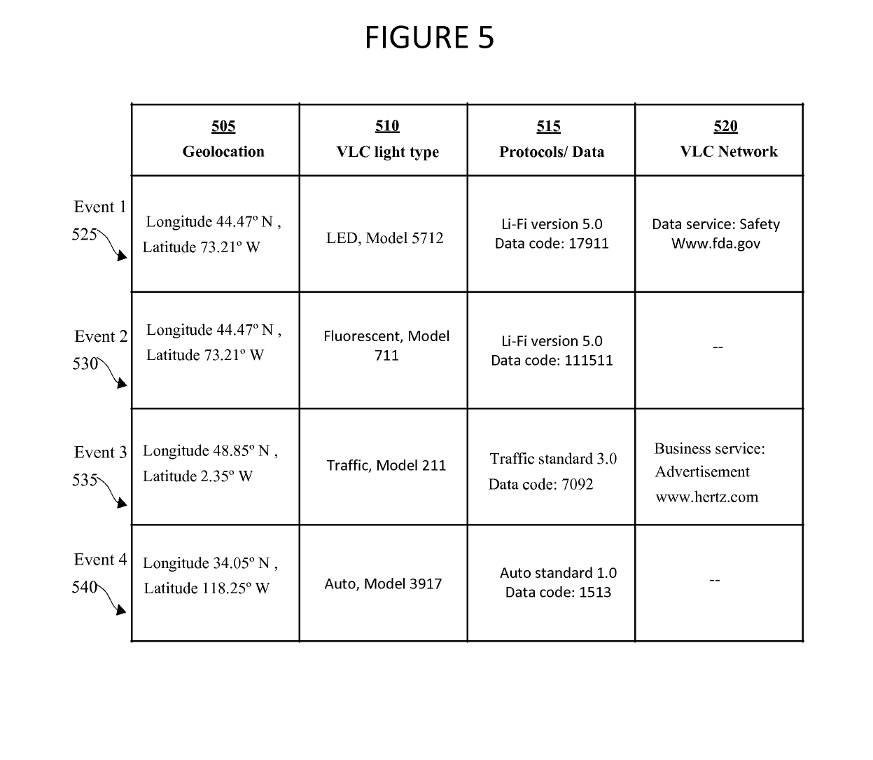

FIG. 5 illustrates an exemplary database 500 on a smart device that may be used in a system for enabling visible light communications on mobile devices. Database 500 may track such fields of data as geo-location 505, a VLC light type 510, protocols/data 515, and VLC network 520.

Each row may represent different events 1-4 525-540. For example, event 1 525 is associated with location longitude 44.47° N and latitude 73.21° W, VLC light type LED model 5712, protocol/data 515 Li-Fi 5.0 using data code 17911, and a FDA safety website. Event 2 530 is associated with location longitude 44.47° N and latitude 73.21° W, VLC light type fluorescent model 711, and Li-Fi version 5.0 using data code 111511. Event 3 is associated with location longitude 48.85° N and latitude 2.35° W, VLC light type traffic model 211, traffic standard 3.0 data code 7092, and a Hertz advertisement business service website. Event 4 is associated with longitude 34.05° N and latitude 118.25° W, and auto model 3917.

Each one of the events 1-4 maps to a location with a specific VLC light type using a particular data protocol. Smart device 105 may use this information to decode and/or decrypt VLC messages communicated by the specific VLC light type using the particular data protocol.

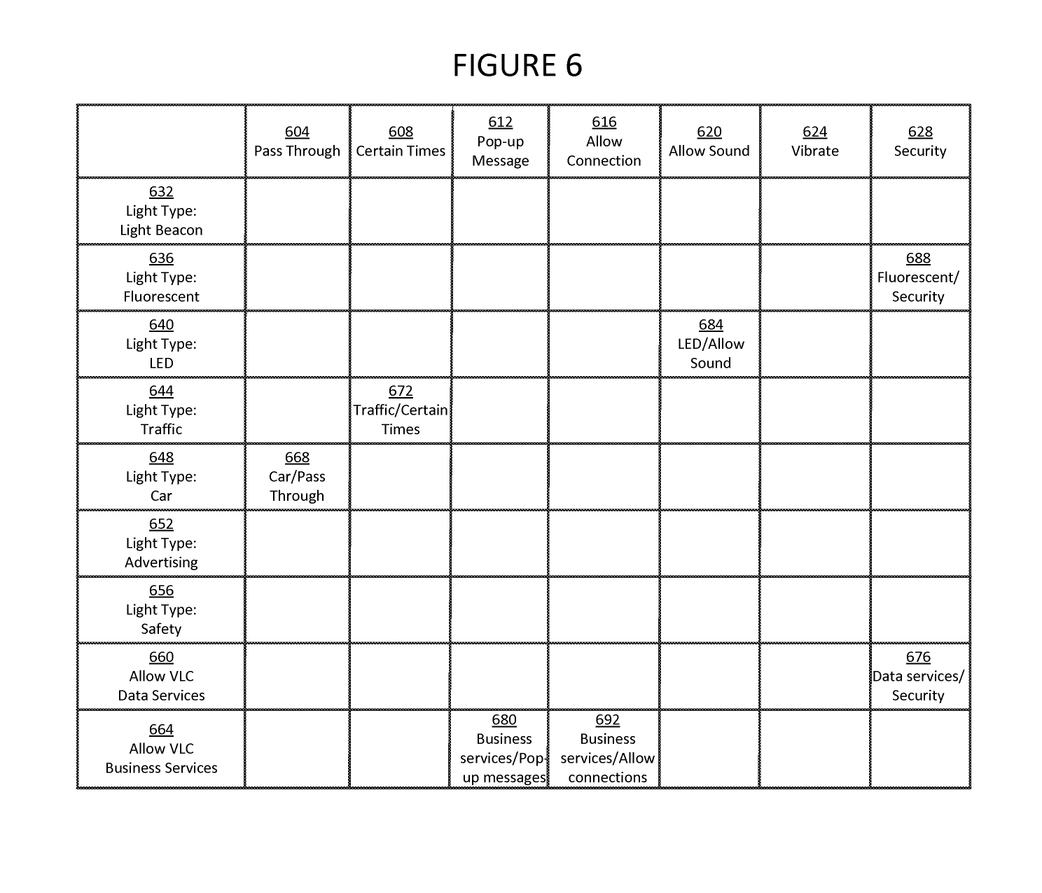

FIG. 6 illustrates another exemplary database 600 on a smart device that may be used in a system for enabling visible light communications on mobile devices. Database 600 may track such fields of data in columns for pass through 604, certain times 608, pop-up message 612, allow connection 616, vibrate 624, and security. Each one of these fields pertain to a setting that may be set in operating system settings of a smart device.

Each row 632-664 represents a different source of VLC communications. Such sources may include beacon 632, fluorescent 636, LED 640, traffic 644, car 648, advertising 652, safety 656, VLC data services 660, and allow VLC business serviced 664. As illustrated, pass through 604 intersects with light type for car 648 at car/pass-through 672. Such a car/pass-through 672 setting enables a smart device in a second car to pass a message received from a first car through to a third car. In this instance, the first car sends a message to a second car, and the second car passes the message through to the third car.

Likewise, certain times 608 column intersects with light type traffic 648 at traffic/certain times 672. Pop up messages 612 intersects with allow VLC business services 644 at business services/pop-up messages messages 680. Allow connection 616 intersects with allow VLC business services 664 at business services/allow connections 692. Allow sound 620 intersects with LED 640 at LED/allow sound 684. Security 628 intersects with fluorescent 636 at fluorescent/security 688. Finally, security 628 intersects with allow VLC data services 660 at data services/security 676.

One embodiment relates to a smart device in a second automobile passing thorough a VLC message received from a smart device in a first automobile to a third automobile. This example is a scenario in which automobile lights, such as taillights, are VLC-enabled. The driver of the first automobile may experience poor road conditions and then activate a vehicle system designed to reduce wheel slippage. This system could also activate the automobile's taillights to broadcast this information via VLC. A smart device belonging to the driver of the second automobile following the first automobile may receive this information and pass the information to a smart device in the third automobile using a VLC communication. Additionally, if the second automobile's smart device has been authorized to use pass-through this data to a safety network, the message may be passed through to the safety network.

Another example relates to an automobile's smart device receiving traffic messages at certain times. This example is a scenario in which a user authorizes a smart device to receive information from VLC-enabled traffic light sources, though only at certain times. For instance, a user may choose not to receive information from VLC-enabled traffic lights during their normal weekday commute. However, the user may authorize receipt of such traffic information on weekends when they are taking longer excursions on unfamiliar routes.

Another example relates to data services being provided to a smart device. This example is a scenario in which a VLC data service provides security information to a user's smart device. In one instance, the state of Florida uses multiple types of VLC light sources to provide hurricane warnings in a chosen area. In another instance, a highway department provides information about construction via VLC light sources along a certain route for the duration of the construction period. In these examples, messages may be transmitted by a series of beacons located next to the highway.

Another example relates to business services being provided to a smart device. This example is a scenario in which VLC business services are authorized to utilize pop-up menus. This combination would allow, for instance, a smart device to receive information from VLC-enabled light sources that would trigger the appearance of pop-up advertisements on the screen of the smart device.

Another example relates to a scenario in which a user has authorized information from VLC-enabled LED sources to produce sounds, such as audio broadcasts or safety signals, on a smart device. In a museum, for instance, VLC-enabled LED sources located near various exhibits could trigger a smart device to play an audio commentary specific to the exhibit being viewed by the user.

Yet another example is a scenario in which VLC-enabled fluorescent lights are authorized to send security information to a smart device. For example, during a fire or similar emergency in an office building, a user could receive location specific safety warnings as he moved passed various fluorescent lights in an attempt to evacuate the building.

Another example is a scenario in which VLC business services are authorized to make connections. For instance, if a user is traveling and passes near a VLC-enabled light source, they may receive a message indicating he should connect to speak with an airline agent. By pre-authorizing the VLC business services to make connections, the user's smart device may be automatically connected with the airline agent using a 4G cellular connection.

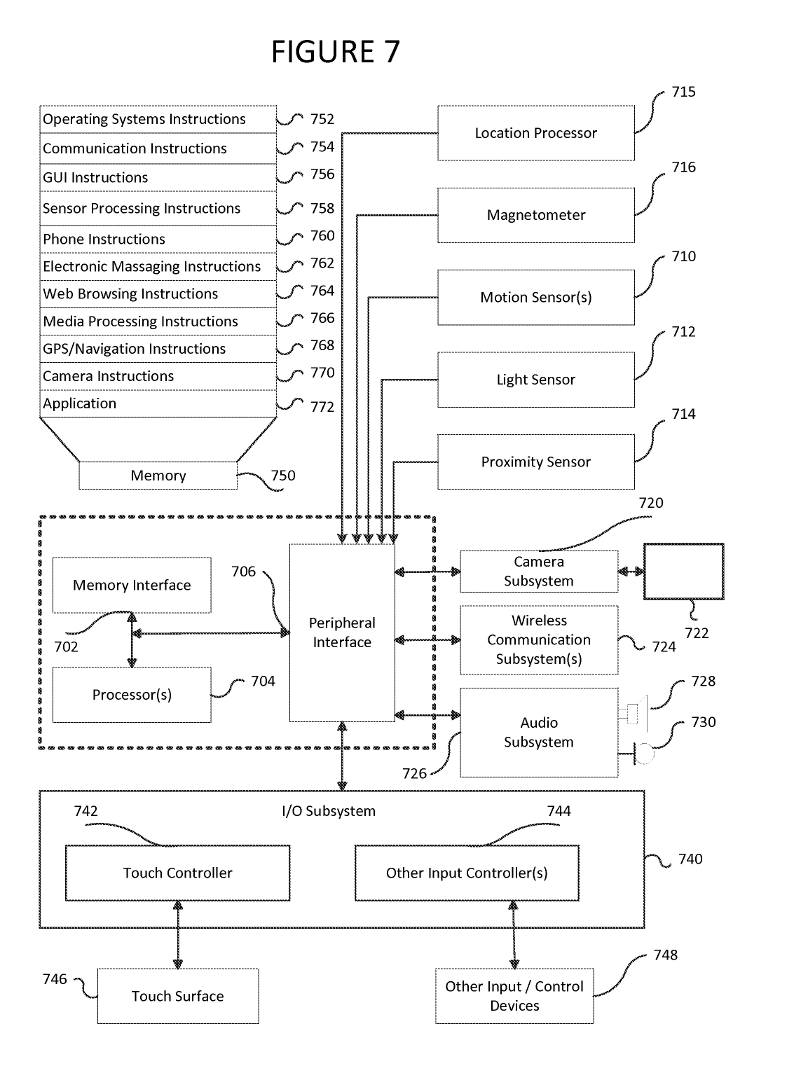

FIG. 7 illustrates a mobile device architecture that may be utilized to implement the various features and processes described herein. Architecture 700 can be implemented in any number of portable devices including but not limited to smart phones, electronic tablets, and gaming devices. Architecture 700 as illustrated in FIG. 7 includes memory interface 702, processors 704, and peripheral interface 706. Memory interface 702, processors 704 and peripherals interface 706 can be separate components or can be integrated as a part of one or more integrated circuits. The various components can be coupled by one or more communication buses or signal lines.

Processors 704 as illustrated in FIG. 7 are meant to be inclusive of data processors, image processors, central processing unit, or any variety of multi-core processing devices. Any variety of sensors, external devices, and external subsystems can be coupled to peripherals interface 706 to facilitate any number of functionalities within the architecture 700 of the exemplar mobile device. For example, motion sensor 710, light sensor 712, and proximity sensor 714 can be coupled to peripherals interface 706 to facilitate orientation, lighting, and proximity functions of the mobile device. For example, light sensor 712 could be utilized to facilitate adjusting the brightness of touch surface 746. Motion sensor 710, which could be exemplified in the context of an accelerometer or gyroscope, could be utilized to detect movement and orientation of the mobile device. Display objects or media could then be presented according to a detected orientation (e.g., portrait or landscape).

Other sensors could be coupled to peripherals interface 706, such as a temperature sensor, a biometric sensor, or other sensing device to facilitate corresponding functionalities. Location processor 715 (e.g., a global positioning transceiver) can be coupled to peripherals interface 706 to allow for generation of geo-location data thereby facilitating geo-positioning. An electronic magnetometer 716 such as an integrated circuit chip could in turn be connected to peripherals interface 706 to provide data related to the direction of true magnetic North whereby the mobile device could enjoy compass or directional functionality. Camera subsystem 720 and an optical sensor 722 such as a charged coupled device (CCD) or a complementary metal-oxide semiconductor (CMOS) optical sensor can facilitate camera functions such as recording photographs and video clips.

Communication functionality can be facilitated through one or more communication subsystems 724, which may include one or more wireless communication subsystems. Wireless communication subsystems 724 can include 802.5 or Bluetooth transceivers as well as optical transceivers such as infrared. Wired communication system can include a port device such as a Universal Serial Bus (USB) port or some other wired port connection that can be used to establish a wired coupling to other computing devices such as network access devices, personal computers, printers, displays, or other processing devices capable of receiving or transmitting data. The specific design and implementation of communication subsystem 724 may depend on the communication network or medium over which the device is intended to operate. For example, a device may include wireless communication subsystem designed to operate over a global system for mobile communications (GSM) network, a GPRS network, an enhanced data GSM environment (EDGE) network, 802.5 communication networks, code division multiple access (CDMA) networks, or Bluetooth networks. Communication subsystem 724 may include hosting protocols such that the device may be configured as a base station for other wireless devices. Communication subsystems can also allow the device to synchronize with a host device using one or more protocols such as TCP/IP, HTTP, or UDP.

Audio subsystem 726 can be coupled to a speaker 728 and one or more microphones 730 to facilitate voice-enabled functions. These functions might include voice recognition, voice replication, or digital recording. Audio subsystem 726 in conjunction may also encompass traditional telephony functions.

I/O subsystem 740 may include touch controller 742 and/or other input controller(s) 744. Touch controller 742 can be coupled to a touch surface 746. Touch surface 746 and touch controller 742 may detect contact and movement or break thereof using any of a number of touch sensitivity technologies, including but not limited to capacitive, resistive, infrared, or surface acoustic wave technologies. Other proximity sensor arrays or elements for determining one or more points of contact with touch surface 746 may likewise be utilized. In one implementation, touch surface 746 can display virtual or soft buttons and a virtual keyboard, which can be used as an input/output device by the user.

Other input controllers 744 can be coupled to other input/control devices 748 such as one or more buttons, rocker switches, thumb-wheels, infrared ports, USB ports, and/or a pointer device such as a stylus. The one or more buttons (not shown) can include an up/down button for volume control of speaker 728 and/or microphone 730. In some implementations, device 700 can include the functionality of an audio and/or video playback or recording device and may include a pin connector for tethering to other devices.

Memory interface 702 can be coupled to memory 750. Memory 750 can include high-speed random access memory or non-volatile memory such as magnetic disk storage devices, optical storage devices, or flash memory. Memory 750 can store operating system 752, such as Darwin, RTXC, LINUX, UNIX, OS X, ANDROID, WINDOWS, or an embedded operating system such as VXWorks. Operating system 752 may include instructions for handling basic system services and for performing hardware dependent tasks. In some implementations, operating system 752 can include a kernel.

Memory 750 may also store communication instructions 754 to facilitate communicating with other mobile computing devices or servers. Communication instructions 754 can also be used to select an operational mode or communication medium for use by the device based on a geographic location, which could be obtained by the GPS/Navigation instructions 768. Memory 750 may include graphical user interface instructions 756 to facilitate graphic user interface processing such as the generation of an interface; sensor processing instructions 758 to facilitate sensor-related processing and functions; phone instructions 760 to facilitate phone-related processes and functions; electronic messaging instructions 762 to facilitate electronic-messaging related processes and functions; web browsing instructions 764 to facilitate web browsing-related processes and functions; media processing instructions 766 to facilitate media processing-related processes and functions; GPS/Navigation instructions 768 to facilitate GPS and navigation-related processes, camera instructions 770 to facilitate camera-related processes and functions; and instructions 772 for any other application that may be operating on or in conjunction with the mobile computing device. Memory 750 may also store other software instructions for facilitating other processes, features and applications, such as applications related to navigation, social networking, location-based services or map displays.

Each of the above identified instructions and applications can correspond to a set of instructions for performing one or more functions described above. These instructions need not be implemented as separate software programs, procedures, or modules. Memory 750 can include additional or fewer instructions. Furthermore, various functions of the mobile device may be implemented in hardware and/or in software, including in one or more signal processing and/or application specific integrated circuits.

Certain features may be implemented in a computer system that includes a back-end component, such as a data server, that includes a middleware component, such as an application server or an Internet server, or that includes a front-end component, such as a client computer having a graphical user interface or an Internet browser, or any combination of the foregoing. The components of the system can be connected by any form or medium of digital data communication such as a communication network. Some examples of communication networks include LAN, WAN and the computers and networks forming the Internet. The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an API that can define on or more parameters that are passed between a calling application and other software code such as an operating system, library routine, function that provides a service, that provides data, or that performs an operation or a computation. The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer may employ to access functions supporting the API. In some implementations, an API call can report to an application the capabilities of a device running the application, such as input capability, output capability, processing capability, power capability, and communications capability.

Users may use any number of different electronic user devices, such as general purpose computers, mobile phones, smartphones, personal digital assistants (PDAs), portable computing devices (e.g., laptop, netbook, tablets), desktop computing devices, handheld computing device, or any other type of computing device capable of communicating over communication network. User devices may also be configured to access data from other storage media, such as memory cards or disk drives as may be appropriate in the case of downloaded services. User device may include standard hardware computing components such as network and media interfaces, non-transitory computer-readable storage (memory), and processors for executing instructions that may be stored in memory.

While various embodiments have been described above, it should be understood that they have been presented by way of example only, and not limitation. The descriptions are not intended to limit the scope of the invention to the particular forms set forth herein. Thus, the breadth and scope of a preferred embodiment should not be limited by any of the above-described exemplary embodiments. It should be understood that the above description is illustrative and not restrictive. To the contrary, the present descriptions are intended to cover such alternatives, modifications, and equivalents as may be included within the spirit and scope of the invention as defined by the appended claims and otherwise appreciated by one of ordinary skill in the art. The scope of the invention should, therefore, be determined not with reference to the above description, but instead should be determined with reference to the appended claims along with their full scope of equivalents.

1. A method for detecting visible light communications by a mobile electronic device, the method comprising:
receiving a selection of a geo-location setting over a user interface;
identifying that a current location of the mobile electronic device matches the selected geo-location, wherein identifying that the current location of the mobile electronic device matches the selected geo-location authorizes the mobile electronic device to receive a visible light communications signal;
receiving a visible light communications signal, wherein the visible light communications signal includes an encoded message;
executing instructions stored in memory, wherein execution of the instructions by a processor decodes the message from the visible light communications signal; and
presenting the message on a screen to a user of the mobile electronic device.

2. The method of claim 1, further comprising storing settings relating to the visible light communications setting in memory of the mobile electronic device.

3. The method of claim 1, further comprising storing the selection of the geo-location setting in memory of the mobile electronic device.

4. The method of claim 3, wherein at least one of the visible light communications setting and the geo-location setting is a setting in the operating system of the mobile electronic device.

5. The method of claim 3, further comprising receiving a radio transmission including information regarding the visible light communication available at the location, and wherein decoding the message is based on the information from the radio transmission.

6. The method of claim 5, wherein the transmission is transmitted from a remote electronic device.

7. The method of claim 5, further comprising:
determining the location of the mobile electronic device; and
communicating the location of the mobile electronic device to an external electronic device, wherein the location is determined and is communicated to the external electronic device before the transmission is received by the mobile electronic device.

8. A non-transitory computer readable storage medium having embodied thereon a program executable by a processor to perform a method for detecting visible light communications by a mobile electronic device, the method comprising:
receiving a selection of a geo-location setting over a user interface;
identifying that a current location of the mobile electronic device matches the selected geo-location, wherein the identifying that the current location of the mobile electronic device matches the selected geo-location authorizes the mobile electronic device to receive a visible light communications signal;
receiving a visible light communications signal, wherein the visible light communications signal includes an encoded message;
decoding the encoded message from the visible light communications signal; and
displaying the message on a display screen to a user of the mobile electronic device.

9. The non-transitory computer readable storage medium of claim 8, further comprising storing settings relating to the visible light communications setting in memory of the mobile electronic device.

10. The non-transitory computer readable storage medium of claim 9, further comprising instructions for storing the selection of the geo-location setting in memory of the mobile electronic device.

11. The non-transitory computer readable storage medium of claim 10, wherein at least one of the visible light communications setting and the geo-location setting is a setting in the operating system of the mobile electronic device.

12. The non-transitory computer readable storage medium of claim 10, further comprising receiving a radio transmission including information regarding the visible light communication available at the location, and wherein decoding the message is based on the information from the radio transmission.

13. The non-transitory computer readable storage medium of claim 12, wherein the transmission is transmitted from a remote electronic device.

14. The non-transitory computer readable storage medium of claim 12, further comprising executable instructions for:
determining the location of the mobile electronic device; and
communicating the location of the mobile electronic device to an external electronic device, wherein the location is determined and is communicated to the external electronic device before the transmission is received by the mobile electronic device.

15. A system for detecting visible light communications by a mobile electronic device, the system comprising:
a user interface that receives a selection of a geo-location setting;
a processor that executes instructions stored in memory that identify that a current location of the mobile electronic device matches the selected geo-location, wherein the identifying that the current location of the mobile electronic device matches the selected geo-location authorizes the mobile electronic device to receive a visible light communications signal;
a sensor that detects a visible light communications signal, wherein the visible light communications signal includes an encoded message, wherein the processor also executes instructions that decodes the message from the visible light communications signal; and
a display screen that presents the message to a user of the mobile electronic device.

16. The system of claim 15, further comprising memory that stores settings relating to the visible light communications setting in memory of the mobile electronic device.

17. The system of claim 16, wherein stores the selection of the geo-location setting is stored in memory of the mobile electronic device.

18. The system of claim 17, further comprising an antenna that receives a radio transmission including information regarding the visible light communication available at the location, and wherein the processor decodes the message based on the information from the radio transmission.

19. The system of claim 18, wherein the transmission is transmitted from a remote electronic device.

20. The system of claim 18, wherein the processor executes further instructions to determine the location of the mobile electronic device, and further comprising a communication interface that communicates the location of the mobile electronic device to an external electronic device, wherein the location is determined and is communicated to the external electronic device before the transmission is received by the mobile electronic device.
